(19) United States
(12) Patent Application Publication
(10) Pub. No.: US 2023/0221794 A1
(43) Pub. Date: Jul. 13, 2023

(54) HEAD MOUNTED DISPLAY DEVICE AND DISPLAY CONTENT CONTROL METHOD

(71) Applicant: HITACHI, LTD., Tokyo (JP)

(72) Inventors: Takuya NAKAMICHI, Tokyo (JP); Shoji YAMAMOTO, Tokyo (JP); Koji YAMASAKI, Tokyo (JP)

(21) Appl. No.: 17/767,487

(22) PCT Filed: Aug. 31, 2020
(86) PCT No.: PCT/JP2020/032836

§ 371 Date: Apr. 8, 2022

(30) Foreign Application Priority Data
Oct. 28, 2019 (JP) 2019-194911

(51) Int. Cl. G06F 3/01; G02B 27/01; G09G 3/00

(52) U.S. Cl. CPC G06F 3/012; G02B 27/0179; G09G 3/001; G02B 2027/0187; G09G 2354/00; G09G 2340/0464; G09G 2320/0613

(57) ABSTRACT

A head mounted display device includes: a mounting state sensor (for example, a sensor) in which a sensor value changes according to a mounting state; a mounting state determination unit for determining a mounting state according to an output of the mounting state sensor; a storage unit for storing a content to be displayed; a content control unit for changing the content stored in the storage unit; and a display unit for displaying the content stored in the storage unit. The content control unit changes the content according to the mounting state output by the mounting state determination unit.

### TECHNICAL FIELD

The present invention relates to a head mounted display device and a display content control method.

### BACKGROUND ART

In recent years, a see-through type head mounted display device (also referred to as a head mounted display) that is worn on a user's head and displays an image of a virtual space superimposed on a real space has attracted attention. In a factory or the like, there is a case where work is performed while viewing content such as a work process, but there is a case where it is difficult to arrange an information display device such as a display near a work target. In such a case, if the see-through type head mounted display device is used, the operator does not need to hold the information display device in the hand or go to see the information display device at a distance, and the work efficiency can be improved.

The display control in the head mounted display device is easy to use by switching the display image according to the state of the head mounted display device or the user. For example, in the head mounted display described in PTL 1, a visual stimulus video is displayed on the outer side with the face as the center according to the mounting position of the head mounted display, whereby the visual field conflict between both eyes is suppressed and the display image is easily viewed.

In addition, in the head mounted display described in PTL 2, information of the user's eye (shape, size, position, inclination, iris pattern) is detected by a camera, and at least a part of the image display mechanism is moved.

### CITATION LIST

### Patent Literature

PTL 1: JP 2019-132900 A

PTL 2: JP 2019-74582 A

### SUMMARY OF INVENTION

### Technical Problem

When an operator performs work while watching content such as a work process, it is important to display the content without feeling uncomfortable or tired. For example, in a case where the user wears a monocular head mounted display device fixed in front of one eye, and if the content is arranged on the opposite side of the eye to which the head mounted display device is mounted as the center of the face, it is difficult to see the content in a case where the user looks for the content by shaking the face to the right. In addition, even in a case where the user wears the binocular type head mounted display device fixed in front of both eyes, the content is difficult to see depending on the relationship between the arrangement of the content and the interest, and in any case, it may hinder the work.

In the method described in PTL 1, the visual stimulus video is displayed on the outside with the face as the center, but the position of the display image is not changed. In addition, in the method described in PTL 2, the display mechanism is controlled by the motions of the eyes of the user, but the content is not easily viewed. Further, since the display mechanism is provided, the size and weight of the head mounted display device increase, which may interfere with the operation.

The present invention has been made to solve the above-described problems, and an object of the present invention is to provide a head mounted display device and a display content control method that make content easily viewable by optimally arranging the content according to the mounting state of the head mounted display device, the nature of the user (usage frequency, number of times of content browsing, and the like), or both.

### Solution to Problem

In order to achieve the above object, a head mounted display device of the present invention includes: a mounting state sensor (for example, a sensor 12) in which a sensor value changes according to a mounting state; a mounting state determination unit for determining a mounting state according to an output of the mounting state sensor; a storage unit for storing a content to be displayed; a content control unit for changing the content stored in the storage unit; and a display unit for displaying the content stored in the storage unit. The content control unit changes the content according to the mounting state output by the mounting state determination unit. Other aspects of the present invention will be described in the following embodiments.

### Advantageous Effects of Invention

According to the present invention, content is optimally arranged according to the mounting state of the head mounted display device and the nature of the user, and the user can comfortably view desired content.

### BRIEF DESCRIPTION OF DRAWINGS

FIG. 1 is a diagram illustrating an appearance of a head mounted display device according to a first embodiment.

FIG. 2 is a diagram illustrating a hardware configuration of the head mounted display device according to the first embodiment.

FIG. 3 is a diagram illustrating a functional configuration of the head mounted display device and a peripheral device thereof according to the first embodiment.

FIG. 4 is a flowchart illustrating processing of a mounting state determination unit according to the first embodiment.

FIG. 5 is a diagram illustrating a method in which a display control unit cuts out display information stored in a storage unit.

FIG. 6A is a diagram illustrating a field of view of an operator and a content arrangeable region according to the first embodiment.

FIG. 6B is a diagram illustrating another example of the field of view of the operator and the content arrangeable region according to the first embodiment.

FIG. 6C is a diagram illustrating still another example of the field of view of the operator and the content arrangeable region according to the first embodiment.

FIG. 7A is a diagram illustrating a content arrangement example when the head mounted display device is worn on the right eye according to the first embodiment.

FIG. 7B is a diagram illustrating a content arrangement example when the head mounted display device is worn on the left eye according to the first embodiment.

FIG. 8 is a diagram illustrating an appearance of a head mounted display device according to a second embodiment.

FIG. 9 is a diagram illustrating a functional configuration of the head mounted display device and a peripheral device thereof according to the second embodiment.

FIG. 10 is a flowchart illustrating processing of a mounting state determination unit according to the second embodiment.

FIG. 11 is a diagram illustrating an appearance of a head mounted display device according to a third embodiment.

FIG. 12 is a diagram illustrating a functional configuration of a head mounted display device and a peripheral device thereof according to a fourth embodiment.

FIG. 13 is a diagram illustrating a functional configuration of a head mounted display device and a peripheral device thereof according to a fifth embodiment.

### DESCRIPTION OF EMBODIMENTS

Embodiments for carrying out the present invention will be described in detail with reference to the drawings as appropriate.

### First Embodiment

In the first embodiment, the mounting state of the head mounted display device of the user is detected by a mounting state detection sensor, and the content in a virtual space is changed and arranged according to the detection. Changing the content includes changing the content or arrangement of the content. The changing of the content is, for example, changing horizontal writing of the content to vertical writing. In the case of Japanese, when the horizontal writing content is arranged on the left side, the horizontal writing content is visually recognized from the end of the sentence, and is difficult to read. In a case where Japanese content is arranged on the left side, it is easy to read the content by vertically writing the content. The changing of the arrangement of the content is to change the position of the content in the virtual space described later. Hereinafter, a configuration for changing the arrangement of content will be described.

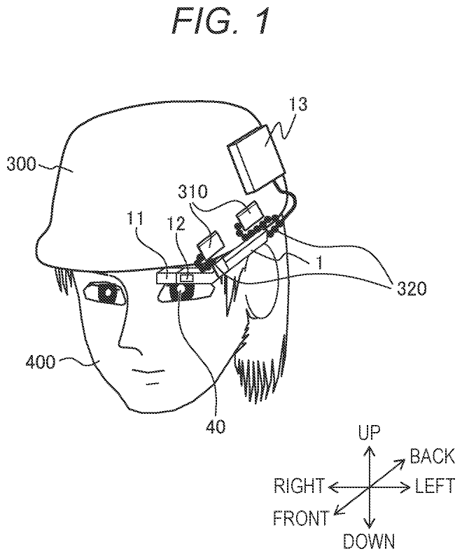

FIG. 1 is an external view of a monocular-type head mounted display device 1 according to a first embodiment. The head mounted display device 1 is configured as a transmissive head mounted display (hereinafter, HMD). Since an operator 400 often wears a helmet 300 in the work support using the HMD, an example in which the HMD is connected to the helmet 300 will be described.

In FIG. 1, a display unit 11 of the head mounted display device 1 is mounted so as to be visually recognizable by the left eye, but the display unit 11 of the head mounted display device 1 can also be mounted so as to be visually recognizable by the right eye. In this case, the head mounted display device 1 is mounted upside down. In a case where the head mounted display device is vertically inverted, a sensor 12 (mounting state sensor) is also vertically inverted.

The head mounted display device 1 includes the display unit 11, the sensor 12, and a controller 13. The display unit 11 is disposed in front of an eye 40 of the operator 400, so that an image can be seen in the line-of-sight direction of the operator 400. The sensor 12 detects the mounting state of the head mounted display device 1 of the operator 400 and the movement of the head of the operator 400.

The controller 13 is assembled to the helmet 300. An arm 320 is extended from a fixing jig 310 fixed to the helmet 300. The head mounted display device 1 is fixed to the helmet 300 by connecting the head mounted display device 1 and the arm 320. The arm 320 is freely bendable and stretchable so that the display unit 11 is disposed at an optimum position of the eye 40. As illustrated in FIG. 1, the head mounted display device 1 may be fixed at two positions. When the fixing is made at only one position, the head mounted display device 1 is easily rotated about the position, so that the positions of the eye 40 and the display unit 11 are easily shifted. When the position is shifted, the image is chipped or blurred, which leads to deterioration in visibility. If the fixing is made at two positions, it is difficult to rotate, so that deterioration in visibility can be suppressed. It is effective that the fixing position is an end portion on the opposite side of the display unit 11 of the head mounted display device 1 and a portion where the head mounted display device 1 is bent in an L shape.

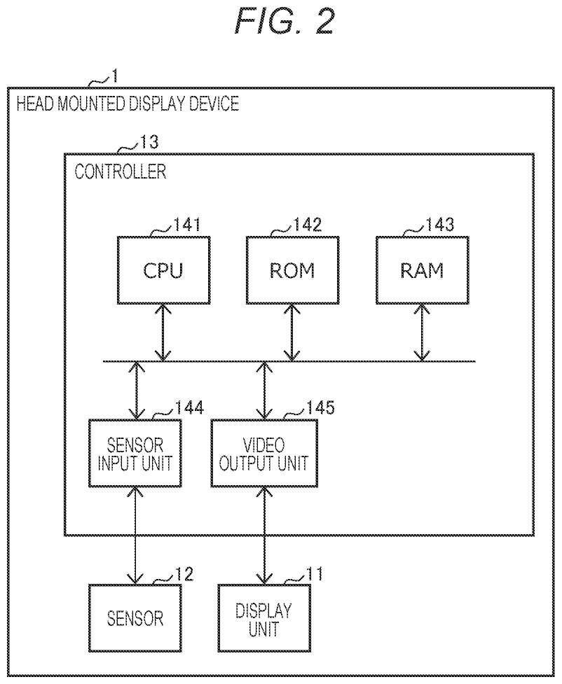

FIG. 2 is a diagram illustrating a hardware configuration of the head mounted display device 1. The hardware of the controller 13 includes a central processing unit (CPU) 141, a read only memory (ROM) 142, a random access memory (RAM) 143, a sensor input unit 144, a video output unit 145, and the like.

The sensor 12 (mounting state sensor) outputs a detection value corresponding to the mounting state and the movement of the head of the operator 400. Here, a sensor fixed to the display unit 11 is illustrated. As a type of the sensor 12, not only an acceleration sensor, an angular velocity sensor, and a geomagnetic sensor but also a camera, a microphone, and the like can be used. In the following description, a sensor capable of acquiring triaxial acceleration and triaxial angular velocity is assumed.

Among the sensors 12, an acceleration sensor, an angular velocity sensor, a geomagnetic sensor, or the like can be used as the head motion sensor.

The CPU 141 executes a program stored in the ROM 142 or the RAM 143. For example, the function of each unit of the head mounted display device 1 is realized by the CPU 141 executing the program. The ROM 142 is a storage medium for storing programs to be executed by the CPU 141 and various parameters necessary for execution. The RAM 143 is a storage medium for storing images and various types of information to be displayed on the display unit 11. The RAM 143 also functions as a temporary storage area for data used by the CPU 141. The head mounted display device 1 may be configured to include a plurality of CPUs 141, a plurality of ROMs 142, and a plurality of RAMs 143.

The sensor input unit 144 acquires a sensor value from the sensor 12. Data may be transmitted and received between the sensor input unit 144 and the sensor 12 by a protocol such as inter-integrated circuit (I2C), serial peripheral interface (SPI), or universal asynchronous receiver transmitter (UART), or the sensor input unit 144 may periodically observe a signal such as a voltage value output from the sensor 12.

The video output unit 145 gives a synchronization signal or the like to an image stored in the ROM 14 or the RAM 15, and transmits the image to the display unit 11.

Note that the hardware configuration of the head mounted display device 1 is not limited to the configuration illustrated in FIG. 2. For example, the CPU 141, the ROM 142, and the RAM 143 may be provided separately from the head mounted display device 1. In that case, the head mounted display device 1 may be realized using a general-purpose computer (for example, a server computer, a personal computer, a smartphone, or the like).

In addition, a plurality of computers may be connected via a network, and each computer may share the function of each unit of the head mounted display device 1. On the other hand, one or more of the functions of the head mounted display device 1 can be realized using dedicated hardware.

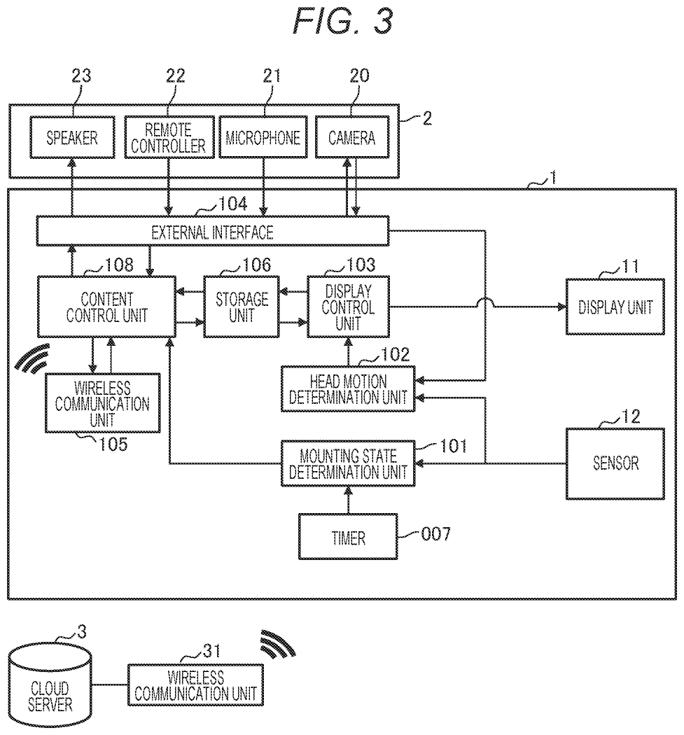

FIG. 3 is a block diagram illustrating a functional configuration of the head mounted display device 1 and a peripheral device thereof according to the first embodiment. The head mounted display device 1 is connected to a peripheral device 2 and a cloud server 3.

The head mounted display device 1 includes a display unit 11, a sensor 12, a mounting state determination unit 101, a head motion determination unit 102, a display control unit 103, an external interface 104, a wireless communication unit 105, a storage unit 106, a timer 107, and a content control unit 108.

The peripheral device 2 includes a camera 20, a microphone 21, a remote controller 22, and a speaker 23. The camera 20 can capture an image around the operator 400. The microphone 21 inputs the voice of the operator 400 to the head mounted display device 1. The remote controller 22 is a device that gives an instruction for video switching, display mode setting, and the like. The speaker 23 supports the work of the operator 400 by voice. The remote controller is an abbreviation for remotely controlling device.

When the head mounted display device 1 communicates with the outside (for example, when the central monitoring room and the operator 400 share the work situation), a wireless communication unit 31 and the cloud server 3 may be provided. The wireless communication unit 105 wirelessly communicates with the wireless communication unit 31. For example, WiFi or Bluetooth is used as the communication means. The wireless communication unit 31 transmits the data received from the wireless communication unit 105 to the cloud server 3. Here, it is assumed that the cloud server 3 is on a remote administrator side and performs sharing of video and audio, change of setting values, data acquisition, and the like on the HMD of the operator 400 from the remote administrator side. The data received by the wireless communication unit 31 may be video data of the camera 20 or audio data input from the microphone 21. The wireless communication unit 31 transmits the data received from the cloud server 3 to the wireless communication unit 105.

The mounting state determination unit 101 determines the mounting state of the operator 400 from the acceleration obtained by the sensor 12. In the head mounted display device 1 of the first embodiment, the display unit 11 is fixed on the side of the face. When the left and right of the head mounted display device 1 are replaced, the top and bottom of the head mounted display device 1 are opposite.

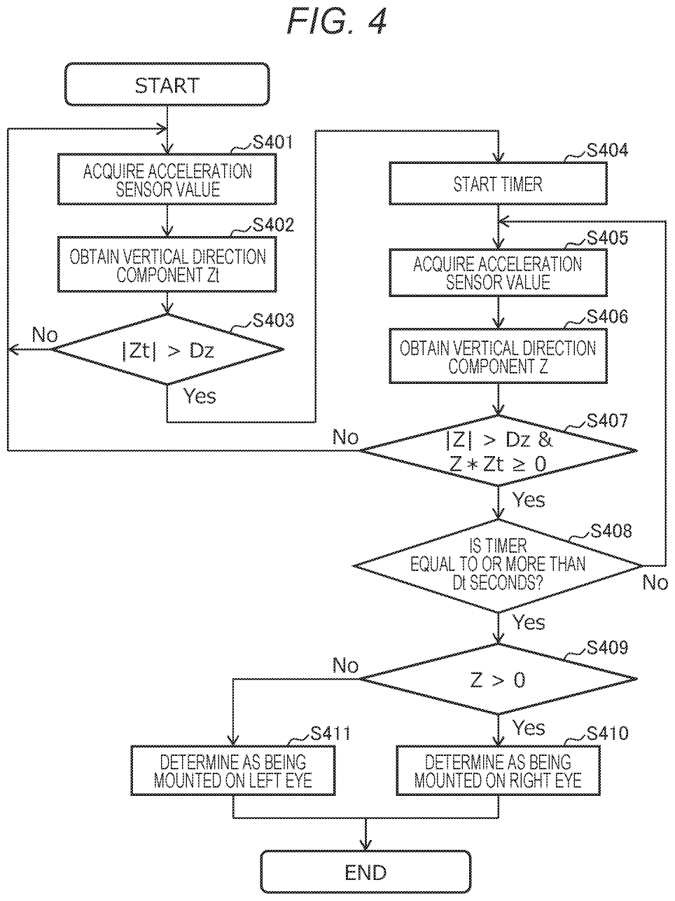

FIG. 4 is a flowchart illustrating processing of the mounting state determination unit 101 according to the first embodiment.

Step S401: The mounting state determination unit 101 acquires an acceleration sensor value from the sensor 12.

Step S402: A vertical component Zt of the HMD coordinate system is obtained from the acquired acceleration sensor value. Specifically, a gravitational acceleration vector G on the three-dimensional orthogonal coordinates in the HMD coordinate system of the head mounted display device 1 is obtained, and the magnitude of the vertical component Zt in the HMD coordinate system is obtained. The HMD coordinate system is a coordinate system fixed to the display unit 11, and the vertical direction of the HMD coordinate system is a direction equal to the vertical direction of the global coordinates when the operator 400 is standing upright. When the coordinate system of the sensor 12 is equal to the HMD coordinate system, the gravitational acceleration vector G can be obtained by substituting three values (Xa, Ya, Za) output from the triaxial acceleration sensor into the elements of the gravitational acceleration vector G and normalizing the elements such that the norm becomes 1. Step S403: It is determined whether the magnitude of the vertical component Zt is larger than a threshold Dz. When it is larger than the threshold Dz (Step S403, Yes), the process proceeds to S404, and when it is equal to or smaller than the threshold Dz (Step S403, No), the process returns to S401.

Step S404: the timer 107 is reset and restarted.

Step S405: An acceleration sensor value is acquired from the sensor 12 in the same manner as in Step S401.

Step S406: A vertical component Z of the HMD coordinate system is obtained from the acceleration sensor value in the same manner as in Step S402.

Step S407: It is determined whether the absolute value of the vertical component Z is larger than the threshold Dz and the signs of the vertical component Z and the vertical component Zt are equal to each other. If true (Step S407, Yes), the process proceeds to Step S408, and if false (Step S407, No), the process returns to Step S401. By determining whether the signs of the vertical component Z and the vertical component Zt are equal, the signs are reversed when the mounting state determination unit 101 determines that the acceleration sensor value is equal to or less than a sampling rate, and when the absolute value of the vertical component Z is large than the threshold Dz, the mounting state determination unit 101 does not determine the right and left.

Step S408: It is determined whether the value of the timer 107 is equal to or more than a threshold Dt seconds. When the value is the threshold Dt or more (Step S408, Yes), the process proceeds to Step S409, and when the value is small (Step S408, No), the process returns to Step S405. As a result, the mounting direction of the head mounted display device 1 can be determined only when the head mounted display device 1 is mounted in the same direction for the threshold Dt seconds or more. When the timer 107 is not used, the mounting state is also determined when the vertical component Z is reversed for a time shorter than the threshold Dt seconds due to the squatting motion, the forward tilting motion, or the like of the operator 400.

Step S409: It is determined whether the vertical component Z is larger than 0. When the vertical component is larger than 0 (Step S409, Yes), the process proceeds to Step S410, and if the vertical component is 0 or less (Step S409, No), the process proceeds to Step S411.

Step S410: It is determined that the head mounted display device 1 is mounted on the right eye.

Step S411: It is determined that the head mounted display device 1 is mounted on the left eye.

However, Steps 5410 and 5411 can be interchanged depending on the direction of the axis in the vertical direction of the HMD coordinate system.

An example of using a uniaxial acceleration sensor will be described as another method in which the mounting state determination unit 101 obtains the vertical component Zt of the HMD coordinate system and the vertical component Z of the HMD coordinate system in Steps 5402 and 5406. The axis of the uniaxial acceleration sensor is installed so as to be equal to the vertical direction of the global coordinates when the operator 400 is stationary. At this time, the vertical component Z of the HMD coordinate system is equal to the sensor value Za.

Returning to FIG. 3, the head motion determination unit 102 calculates where the head faces in the global coordinate system. At least a yaw angle Ry and a pitch angle Rp in the global coordinate system of the head mounted display device 1 are calculated. The yaw angle Ry and the pitch angle Rp can be obtained by repeating rotation calculation based on sensor values of the triaxial angular velocity sensor included in the sensor 12. In addition, the accuracy of the yaw angle Ry and the pitch angle Rp can be improved by combining the triaxial angular velocity sensor included in the sensor 12 and the triaxial acceleration sensor included in the sensor 12. At this time, a generally known Kalman filter or Madgwick filter can be used to calculate the yaw angle Ry and the pitch angle Rp.

The display control unit 103 extracts the display information stored in the storage unit 106 according to the yaw angle Ry and the pitch angle Rp output from the head motion determination unit 102, and outputs the display information as a video signal to the display unit 11.

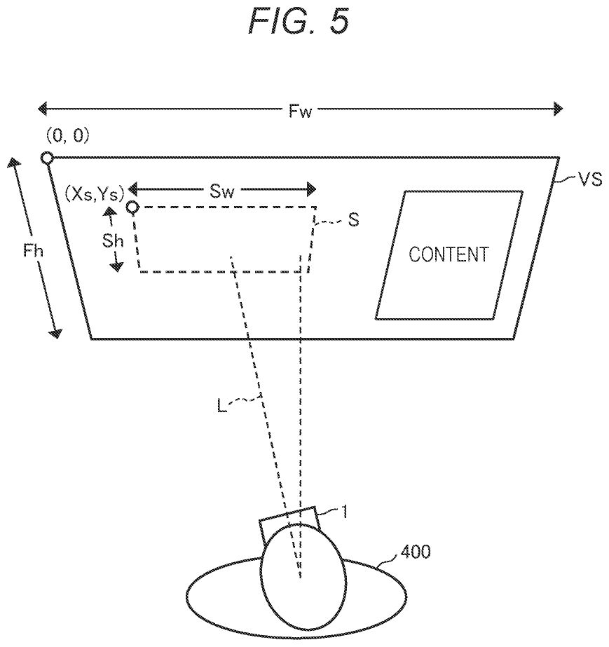

FIG. 5 is a diagram illustrating a method in which the display control unit 103 cuts out the display information stored in the storage unit 106. The storage unit 106 stores a virtual space VS. The virtual space VS is a two-dimensional image including a content image, and has Fw pixels in the horizontal direction (X-axis direction) and Fh pixels in the vertical direction (Y-axis direction). The origin pixel (X, Y)=(0, 0) of the virtual space VS is stored at an origin address ADDR, and is stored in the memory in the storage unit 106 so that the horizontal direction of the virtual space VS is continuous. A pixel (Fw, 0) and a pixel (0, 1) are stored in a continuous region on the memory.

The display area S is an area in the virtual space VS actually displayed on the display unit 11. The display control unit 103 appropriately cuts out the display area S from the virtual space VS. The display area S is a two-dimensional image, and when the head of the operator 400 faces the line of sight L, the display area S is Sw pixels in the horizontal direction (X-axis direction) and Sh pixels in the vertical direction (Y-axis direction) with a pixel (Xs, Ys) in the virtual space VS as the origin.

The display control unit 103 obtains Xs and Ys, and outputs the display area S corresponding thereto. Here, Xs and Ys are obtained by the following Expression. Note that FOV (Field of View) in the horizontal direction of the display unit 11 is FOVw [°], and FOV in the vertical direction is FOVh [°].

Xs=(Fw−Sw)/2−(Ry*Sw)/FOVwYs=(Fh−Sh)/2−(Rp*Sh)/FOVh

In this method, when both the yaw angle Ry and the pitch angle Rp are 0 [°], the center pixel (Fw/2, Fh/2) of the virtual space VS and the center pixel (Xs+Sw/2, Ys+Sh/2) of the display area S become the same pixel.

By this method, the operator 400 can perceive the virtual space VS as being fixed in the real space, and can selectively display necessary content at that time.

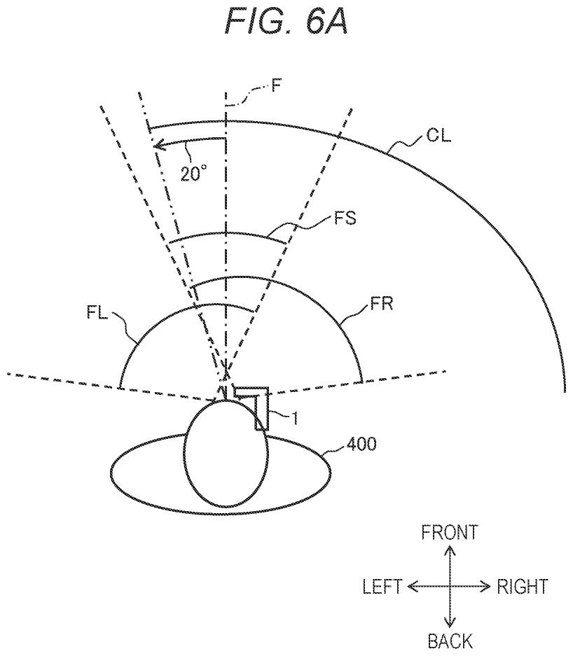

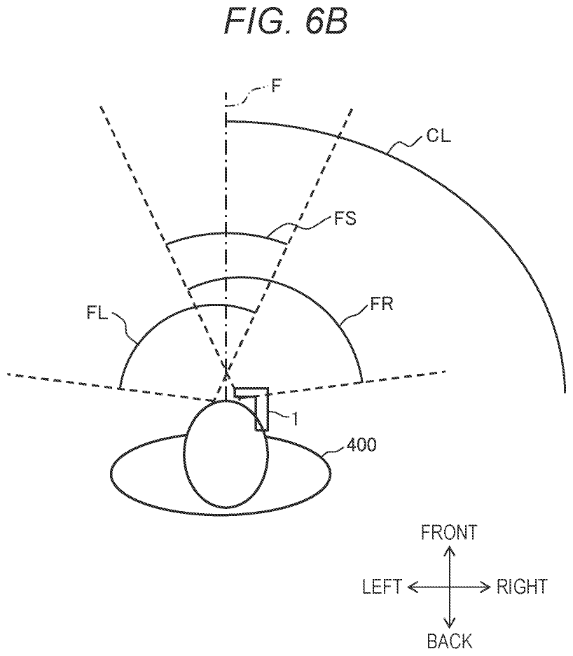

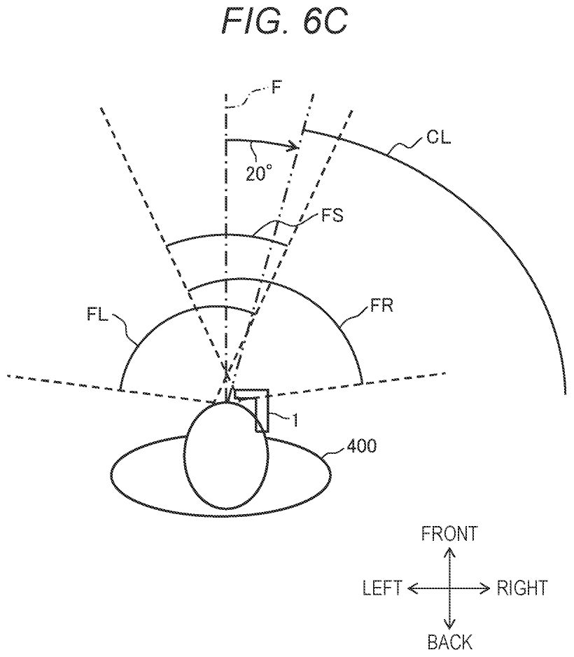

FIGS. 6A to 6C are diagrams illustrating the field of view of the operator 400 and a content arrangeable region CL. The operator 400 wears the head mounted display device 1 so that the display unit 11 can be visually recognized with the right eye. The operator 400 perceives an image included in a right-eye visual field FR with the right eye and perceives an image included in a left-eye visual field FL with the left eye. In addition, a both-eye visual field FS is a field of view in which the right-eye visual field FR and the left-eye visual field FL overlap with each other. Since the head mounted display device 1 is a monocular type, the operator can perceive an image only by either the right eye or the left eye. For example, when the head mounted display device 1 is mounted on the right eye, and content is displayed in a field of view obtained by subtracting the both-eye visual field FS from the left-eye visual field FL, the operator 400 cannot perceive the content.

In addition, even when the operator can perceive the display unit 11 of the head mounted display device 1 worn on the right eye only by the right-eye field of view, it is known that content arranged in the vicinity of the left-eye visual field FL in the virtual space VS is difficult to see with the right eye. Therefore, by appropriately changing the arrangement of the content according to the mounting state of the head mounted display device 1, it is possible to provide the head mounted display device in which the content is easily viewed.

FIG. 6A is a diagram in which the mounting side from 20° on the opposite side of the mounting with reference to a front face F is set as the content arrangeable region CL. It is known that a human tries to visually recognize with the eye on the side where the visual angle stimulus is present when there is a visual stimulus outside about 20° with respect to the front face. By setting the mounting side from 20° on the opposite side of the mounting as the content arrangeable region, it is possible to prevent the content from being visually recognized by the eyes of the non-mounting side. Note that the angle 20° may be appropriately changed because there are individual differences.

FIG. 6B is a diagram in which the mounting side from the front face F is the content arrangeable region CL. As compared with the case of FIG. 6A, the content can be visually recognized with the eyes of the further mounting side.

FIG. 6C is a diagram in which the mounting side from 20° on the mounting side is set as the content arrangeable region CL with reference to the front face F. At this time, the content is visually recognized with almost only the right eye.

Returning to FIG. 3, the content control unit 108 controls the content included in the virtual space VS in the storage unit 106. The content control includes changing any of the position, the character color, the background color, and the size of the content, and the content.

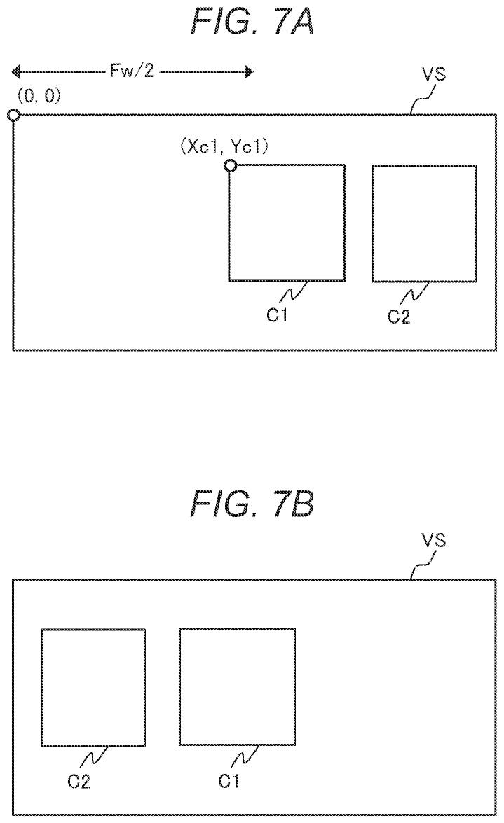

FIG. 7A illustrates an example of content arrangement in a case where the operator 400 wears the head mounted display device 1 on the right eye. A content C1 and a content C2 are arranged on the virtual space VS. The origin of the content C1 is a pixel (Xc1, Yc1) in the virtual space VS. The center of the both-eye visual field FS in the initial state is set to pass through the center pixel (Fw/2, Fh/2) of the virtual space VS. At this time, the content control unit 108 changes the positions of the content C1 and the content C2 so that the content C1 and the content C2 are included in the content arrangeable region CL. The center of the right-eye visual field FR in the initial state may be set to pass through the center pixel (Fw/2, Fh/2) of the virtual space VS.

FIG. 7B illustrates an example of content arrangement in a case where the operator 400 wears the head mounted display device 1 on the left eye. Similarly to the case of the right eye, the content control unit 108 changes the positions of the content C1 and the content C2 so that the content C1 and the content C2 are included in the content arrangeable region CL.

The positions of the content C1 and the content C2 can be changed according to the importance level of each content. The importance level of each content is stored in the storage unit 106. The content control unit 108 compares the importance levels of the respective contents, and changes the position of the content having a high importance level to the vicinity of the visual field center of the eye determined by the mounting state determination unit 101. At this time, the positions of the respective contents are changed so as not to overlap each other.

The positions of the content C1 and the content C2 can be changed according to the content type of each content. The content type is, for example, an image type, a horizontal writing Japanese character string type, a vertical writing Japanese character string type, or the like. The content type of each content is stored in the storage unit 106. The content control unit 108 changes the position of the content according to the content type. For example, when the content type is the horizontal writing Japanese character string type, the content is arranged on the right side. This is because horizontal writing in Japanese continues from left to right, and the operator 400 can perceive the characters from the left side of the character string by arranging the characters on the right side.

Where in the real space the center pixel (Fw/2, Fh/2) of the virtual space VS passes through can be set by the peripheral device 2. For example, the yaw angle Ry and the pitch angle Rp of the head motion determination unit 102 can be reset by the operator 400 operating the remote controller 22 while facing a direction in which the center pixel (Fw/2, Fh/2) of the virtual space VS is desired to be set. In this reset, the yaw angle Ry and the pitch angle Rp may be set to 0, or only the yaw angle Ry may be set to 0. By not setting the pitch angle Rp to 0, the vertical position of the virtual space VS can be maintained even after resetting.

The content control unit 108 can change the content by a signal output from the peripheral device 2 or the wireless communication unit 105.

According to the first embodiment, by determining the mounting state and changing the arrangement of the content in the virtual space according to the determined mounting state, it is possible to realize the head mounted display device in which the content can be easily viewed regardless of which eye the head mounted display device is worn.

### Second Embodiment

In the second embodiment, an example in which a microphone is included as the sensor 12 will be described. The same configurations as those of the first embodiment are denoted by the same reference numerals, and detailed description thereof will be omitted.

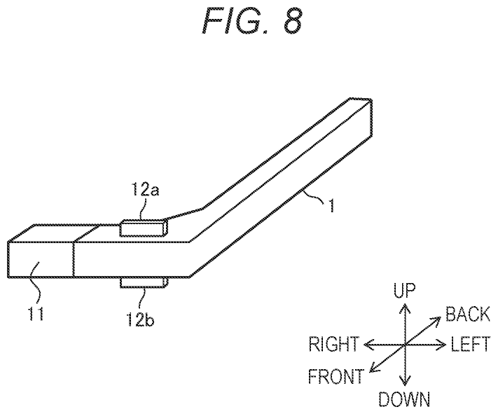

FIG. 8 is an external view of the head mounted display device 1 using a microphone as the sensor 12. The head mounted display device includes a microphone 12a and a microphone 12b. The microphones are installed so as to sandwich the head mounted display device 1, and a straight line connecting the microphones becomes vertical when the operator 400 wears the head mounted display device 1. When the head mounted display device 1 is mounted on the opposite side, the microphone 12b is on the upper side and the microphone 12a is on the lower side.

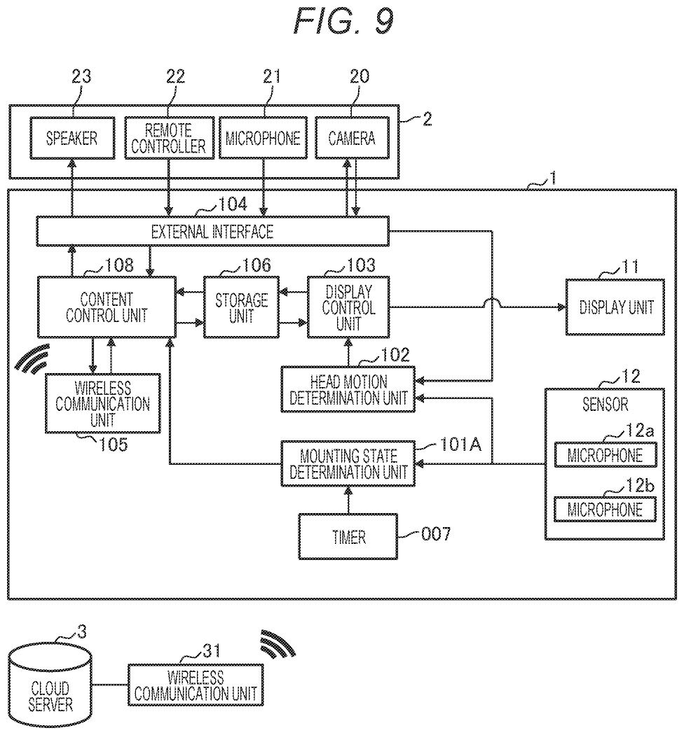

FIG. 9 is a block diagram illustrating a functional configuration of the head mounted display device 1 according to the second embodiment and its periphery. Instead of the mounting state determination unit 101 in the first embodiment, a mounting state determination unit 101A is provided. The mounting state determination unit 101A determines which of the left and right eyes the head mounted display device 1 is worn on according to a sound volume Va and a sound volume Vb output from the microphone 12a and the microphone 12b.

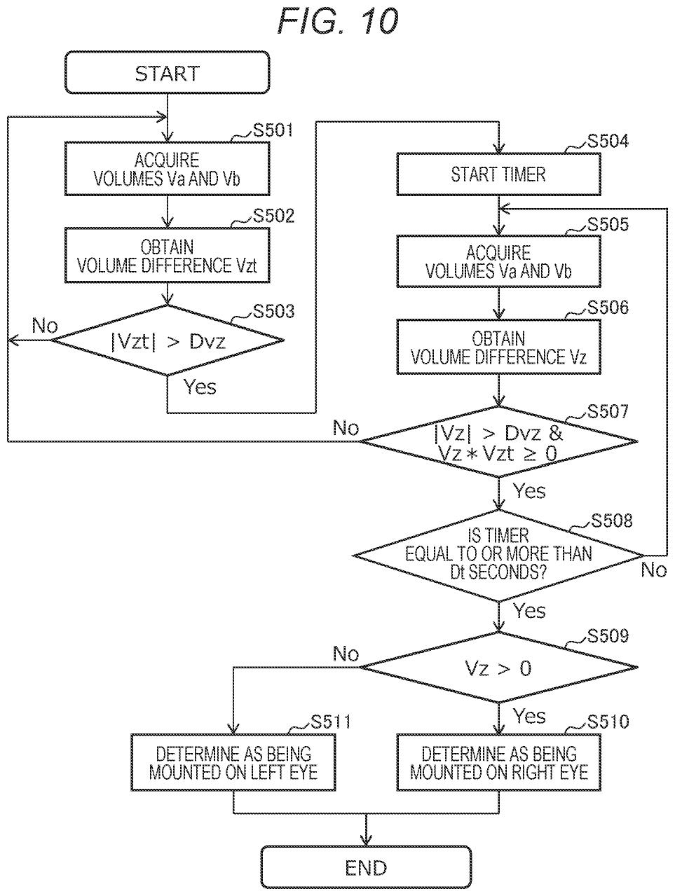

FIG. 10 is a flowchart illustrating processing of the mounting state determination unit 101A according to the second embodiment. With this processing, it is possible to determine whether the head mounted display device 1 is mounted on the right or left by the volume difference between the microphone 12a and the microphone 12b generated when the operator 400 utters a voice.

Step S501: The mounting state determination unit 101A acquires the sound volume Va and the sound volume Vb output from the microphone 12a and the microphone 12b.

Step S502: A sound volume difference Vzt between the sound volumes Va and Vb is obtained.

Step S503: It is determined whether the magnitude of the sound volume difference Vzt is larger than a threshold Dvz. In a case where it is larger than the threshold Dvz (Step S503, Yes), the process proceeds to S504, and in a case where it is equal to or smaller than the threshold Dvz (Step S503, No), the process returns to S501.

Step S504: The timer 107 is reset and starts. Step S505: The sound volume Va and the sound volume Vb output from the microphone 12a and the microphone 12b are acquired in the same manner as in Step S501.

Step S506: A sound volume difference Vz between the sound volumes Va and Vb is obtained in the same manner as in Step S502.

Step S507: It is determined whether the absolute value of the sound volume difference Vz is larger than the threshold Dvz and the signs of the sound volume difference Vz and the sound volume difference Vzt are equal to each other. If true (Step S507, Yes), the process proceeds to Step S508, and if false (Step S507, No), the process returns to Step S501.

Step S508: It is determined whether the value of the timer 107 is equal to or more than the threshold Dt seconds. In a case where it is the threshold Dt or more (Step S508, Yes), the process proceeds to Step S509, and in a case where it is small (Step S508, No), the process returns to Step S505.

Step S509: It is determined whether the sound volume difference Vz is larger than 0. In a case where it is larger than 0 (Step S509, Yes), the process proceeds to Step S510, and in a case where it is 0 or less (Step S509, No), the process proceeds to Step S511.

Step S510: It is determined that the head mounted display device 1 is mounted on the right eye.

Step S511: It is determined that the head mounted display device 1 is mounted on the left eye.

However, Steps S510 and S511 can be interchanged depending on the direction of the axis in the vertical direction of the HMD coordinate system.

The sound volumes Va and Vb output from the microphone 12a and the microphone 12b may be sound volumes of only human voice. In that case, it can be realized by a band pass filter that cuts off other than human voice.

Note that the microphone 12a and the microphone 12b can also be installed in the peripheral device 2. At this time, the sound volume Va and the sound volume Vb are input to the mounting state determination unit 101A via the external interface 104.

According to the second embodiment, it is possible to determine which one of the left and right eyes the head mounted display device 1 is mounted on by determining the direction of the mouth by two microphones. Accordingly, even when the forward tilting motion or the squatting motion is performed, the mounting state of the head mounted display device 1 can be correctly determined.

### Third Embodiment

In the third embodiment, an example in which an illuminance sensor is included as the sensor 12 will be described. Note that the components having the same configurations and functions as those of the first and second embodiments are denoted by the same reference numerals, and a detailed description thereof will be omitted.

In general, light is often incident from above the head of the operator 400. For example, in the case of indoor, there is illumination on the ceiling, and in the case of outdoor, there is the sun in the sky, and light enters from above. That is, by detecting the direction in which the light is strong, it is possible to determine which one of the left and right eyes the head mounted display device 1 is mounted on.

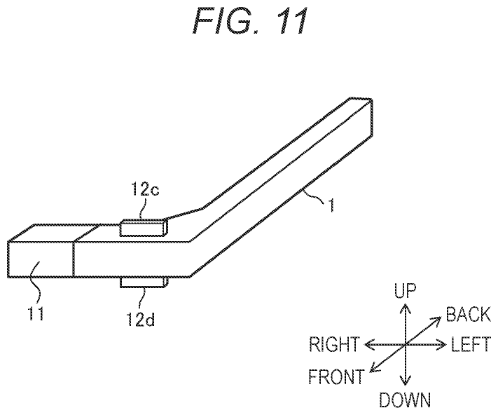

FIG. 11 is an external view of the head mounted display device 1 using an illuminance sensor as the sensor 12. The head mounted display device 1 according to the third embodiment is obtained by replacing the microphone 12a according to the second embodiment with an illuminance sensor 12c and replacing the microphone 12b with an illuminance sensor 12d. As in the second embodiment, when the head mounted display device 1 is mounted on the opposite side, the illuminance sensor 12d is on the upper side and the illuminance sensor 12c is on the lower side.

Each of the illuminance sensor 12c and the illuminance sensor 12d outputs illuminance. The mounting state determination method of the head mounted display device 1 in the third embodiment can be realized by replacing the sound volume Va and the sound volume Vb in the second embodiment with illuminance.

Note that the illuminance sensor 12c and the illuminance sensor 12c can also be installed in the peripheral device 2. At this time, the illuminance is input to the mounting state determination unit 101A via the external interface 104.

According to the third embodiment, it is possible to determine which one of the left and right eyes the head mounted display device 1 is mounted on by determining the direction of light by the two illuminance sensors. As a result, even when the second embodiment cannot be applied in a high noise environment or the like, the mounting state of the head mounted display device 1 can be determined.

### Fourth Embodiment

In the fourth embodiment, an example in which the position of the content is changed on the basis of the mounting state or the interest information input by the operator 400 will be described. Note that the components having the same configurations and functions as those of the first to third embodiments are denoted by the same reference numerals, and a detailed description thereof will be omitted.

The head mounted display device 1 in the fourth embodiment may be a monocular type or a binocular type. In the head mounted display device of the binocular type, both the left and right eyes can visually recognize the display of the display unit 11.

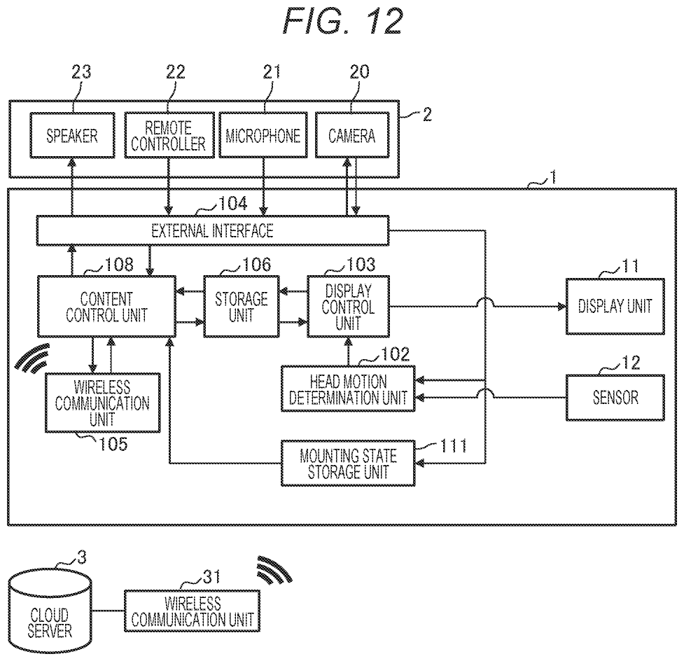

FIG. 12 is a block diagram illustrating a functional configuration of the head mounted display device 1 according to the fourth embodiment and its periphery. The head mounted display device 1 includes a mounting state storage unit 111. The mounting state storage unit 111 stores the mounting state of the head mounted display device 1 or the interest information of the operator 400. The mounting state and the interest information can be input from the peripheral device 2 via the external interface 104.

For example, the mounting state and the interest information can be obtained from the result of voice recognition of the voice data obtained from the microphone 21. In addition, a right-eye mounting button and a left-eye mounting button are arranged on the remote controller, and the mounting state and the interest information can be obtained by pressing the buttons. Further, the quick response (QR) code (registered trademark) in which a setting value is incorporated can be read by a camera to obtain the mounting state and the interest information.

The content control unit 108 changes the position of the content in the virtual space VS according to the mounting state or the interest information stored in the mounting state storage unit 111. When the interest information stored in the mounting state storage unit 111 is the left eye, the position of the content is changed similarly to when the mounting state is the left, and when the interest information stored in the mounting state storage unit 111 is the right eye, the position of the content is changed similarly to when the mounting state is the right eye.

According to the fourth embodiment, the position of the content can be changed to be easily viewable by the user's input.

### Fifth Embodiment

The fifth embodiment is an example in which the importance level of the content is determined according to the line of sight of the operator 400, and the position of the content is changed from the content importance level. Note that the components having the same configurations and functions as those of the first to fourth embodiments are denoted by the same reference numerals, and a detailed description thereof will be omitted.

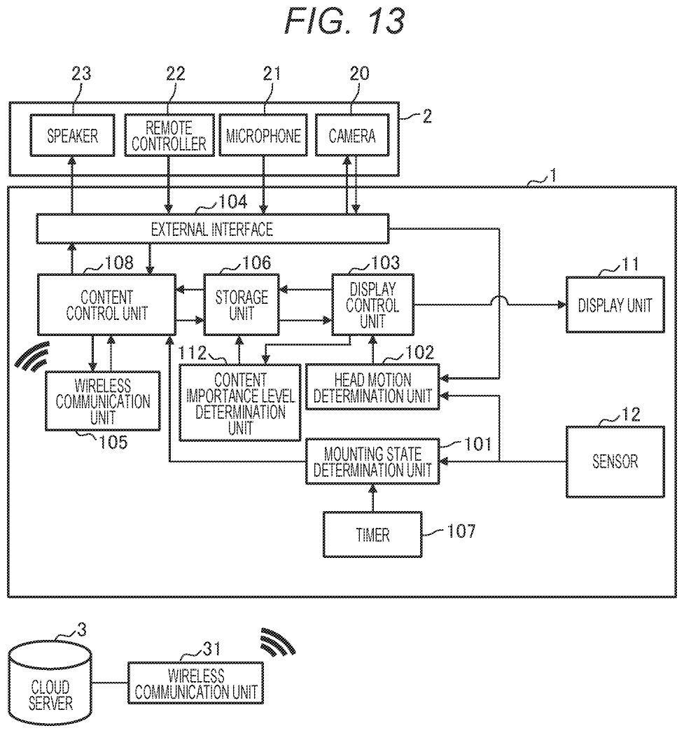

FIG. 13 is a block diagram illustrating a functional configuration of the head mounted display device 1 and its periphery according to the fifth embodiment. The head mounted display device 1 includes a content importance level determination unit 112.

The content importance level determination unit 112 changes the importance level of each content stored in the storage unit 106 according to the line of sight of the operator 400. The line of sight of the operator 400 is a straight line connecting the center pixel (Xs+Sw/2, Ys+Sh/2) of the display area S and the center of the eye 40. When the content is included in the center pixel of the display area S, the content importance level determination unit 112 increases the importance level of the content. This can increase the importance level of frequently viewed content. The content importance level determination unit 112 can also increase the importance level of the content only when the content is continuously viewed for a certain period of time. As a result, for example, when the content C2 is viewed beyond the content C1, the importance level of the content C2 can be increased without increasing the importance level of the content C1.

As described in the first embodiment, the content control unit 108 compares the importance levels of the respective contents, and changes the position of the content having a high importance level to the vicinity of the visual field center of the eye determined by the mounting state determination unit 101. At this time, the positions of the respective contents are changed so as not to overlap each other.

<Modifications>

The present invention is not limited to the above-described embodiments, but various modifications may be contained. For example, the above-described embodiments of the invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

### REFERENCE SIGNS LIST

1 head mounted display device
2 peripheral device
3 cloud server
11 display unit
12 sensor (mounting state sensor, head motion sensor)
12a, 12b microphone
12c, 12d illuminance sensor
13 controller
40 eye
101, 101A mounting state determination unit
102 head motion determination unit
103 display control unit
104 external interface
105 wireless communication unit
106 storage unit
107 timer
108 content control unit
111 mounting state storage unit
300 helmet
310 fixing jig
320 arm
400 operator
CL content arrangeable region
F front face
FL left-eye visual field
FR right-eye visual field
FS both-eye visual field
L line of sight
S display area
VS virtual space

1. A head mounted display device comprising:
a mounting state sensor in which a sensor value changes according to a mounting state;
a mounting state determination unit for determining a mounting state according to an output of the mounting state sensor;
a storage unit for storing a content to be displayed;
a content control unit for changing the content stored in the storage unit; and
a display unit for displaying the content stored in the storage unit, wherein
the content control unit changes the content according to the mounting state output by the mounting state determination unit.

2. The head mounted display device according to claim 1, wherein
the mounting state sensor is a head motion sensor that detects a motion of a head,
the head mounted display device comprises:
a head motion determination unit for determining the motion of the head according to a sensor value of the head motion sensor; and
a display control unit for cutting out and outputting a video stored in the storage unit according to the determination of the head motion determination unit.

3. The head mounted display device according to claim 1, comprising:
an external interface for communicating with an outside, wherein
the content control unit changes the content stored in the storage unit according to an input of an input device connected to the external interface.

4. The head mounted display device according to claim 1, wherein
the content control unit changes a position of the content stored in the storage unit to a mounting side according to the determination of the mounting state determination unit.

5. The head mounted display device according to claim 3, wherein
the external interface outputs a mounting state according to the input of the input device, and
the content control unit changes a position of the content stored in the storage unit to a mounting side according to the output of the external interface.

6. The head mounted display device according to claim 4, wherein
the mounting side is a mounting side from 20° on an opposite side of mounting with reference to a front face.

7. The head mounted display device according to claim 4, wherein the mounting side is a mounting side from a front face.

8. The head mounted display device according to claim 4, wherein
the mounting side is a mounting side from 20° on a mounting side with respect to a front face.

9. The head mounted display device according to claim 1, wherein
the mounting state sensor is an acceleration sensor, and
when an absolute value of a sensor value of the acceleration sensor exceeds a threshold for a certain period time or more, the mounting state determination unit determines the mounting state according to whether the sensor value is positive or negative.

10. The head mounted display device according to claim 1, wherein
the mounting state sensor is two or more illuminance sensors, and
when a difference between sensor values of the two or more illuminance sensors exceeds a threshold for a certain period of time or more, the mounting state determination unit determines the mounting state according to whether the difference is positive or negative.

11. The head mounted display device according to claim 1, wherein
the mounting state sensor is two or more microphones, and
when a difference between volumes of the two or more microphones exceeds a threshold for a certain period of time or more, the mounting state determination unit determines the mounting state according to whether the difference is positive or negative.

12. The head mounted display device according to claim 1, further comprising:
a content importance level determination unit for changing an importance level of the content stored in the storage unit, wherein
the content importance level determination unit changes the importance level of the content stored in the storage unit according to an input of an input device connected to an external interface, and
the content control unit changes a position of the content stored in the storage unit according to the importance level of the content.

13. The head mounted display device according to claim 12, wherein
the content importance level determination unit changes the importance level of the content stored in the storage unit according to a content appearing at a center of an image output by the display control unit.

14. A display content control method of a head mounted display device including a mounting state sensor in which a sensor value changes according to a mounting state, a mounting state determination unit for determining a mounting state according to an output of the mounting state sensor, a storage unit for storing a content to be displayed, a content control unit for changing the content stored in the storage unit, and a display unit for displaying the content stored in the storage unit, wherein
the content control unit changes the content according to the mounting state output by the mounting state determination unit.
